(19) United States
(12) Patent Application Publication
(10) Pub. No.: US 2007/0008593 A1
(43) Pub. Date: Jan. 11, 2007

(54) Communication equipment and image output system

(75) Inventor: Shougo Sato, Seto-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: BROTHER KOGYO KABUSHIKI KAISHA, Nagoya-shi (JP)

(21) Appl. No.: 11/481,813

(22) Filed: Jul. 7, 2006

(30) Foreign Application Priority Data
Jul. 8, 2005 (JP) 2005-199780

(51) Int. Cl. H04N 1/46

(52) U.S. Cl. 358/501

(57) ABSTRACT

A communication equipment comprises: an image reading unit that reads an image on a sheet; a read-image storage unit that stores the image read by the image reading unit; a first transmission unit that transmits the image stored in the read-image storage unit to an external equipment according to a transmission job; a monitor unit that determines whether the image is transmitted to the external equipment by the first transmission unit; a history-image storage unit that stores a history image, which is determined to be transmitted to the external equipment; a history-printing instruction unit that gives an instruction to print plural pages of the history image, stored in the history-image storage unit, on every one sheet according to a manipulation; and a printing unit that prints the plural pages of the history image on every one sheet on a basis of the instruction from the history-printing instruction unit.

### CROSS REFERENCE TO RELATED APPLICATION

This application claims priority from Japanese Patent Application No. 2005-199780, filed Jul. 8, 2005, the contents of which are hereby incorporated by reference into the present application.

### TECHNICAL FIELD

Aspects of the present invention relate to an image output system comprising a communication equipment such as a facsimile apparatus or a multifunctional machine, and an information terminal device for transmitting image data and commands to the communication equipment and to the communication equipment.

### BACKGROUND

Heretofore, a communication equipment, such as a facsimile transmitting and receiving image data via a telephone line with which the image data can be checked, has been known.

JP-A-2004-015525, for example, discloses a communication equipment comprising: a manipulation unit, which instructs printing of images waiting for transmission accumulated in an image memory; and a control unit that controls printing, according to the printing instruction, of an image corresponding to one or more transmission jobs accumulated in the image memory on a sheet. The image corresponding to each transmission job accumulated in the image memory is subjected to N-in-one printing (N being a natural number) in accordance with the printing instruction.

In this way, according to JP-A-2004-015525, a user can readily know the content of an image accumulated in the image memory from a sheet on which the accumulated image waiting for transmission accumulated in the image memory is subjected to the N-in-one printing. Since the accumulated images are concentrated by the N-in-one printing, an amount of sheets can be saved, and a time period for forming images and for checking images formed on the sheet can be reduced. An upper limit of a number of images formed on one sheet is designated, whereby shrinking the image size too much can be prevented so that the content of the image can be identified. The formation of image data with a larger number of images than the upper limit can be divided onto plural sheets.

In some cases, however, images are transmitted by facsimile sequentially, i.e. different from a transmission after accumulating all images to be transmitted in a memory. When a defect in image quality, such as a striped image or an entirely black image, has occurred, the communication equipment of JP-A-2004-015525 cannot detect the defect. The communication equipment cannot detect such a trouble that an image is improperly transmitted by specifying a wrong address. On the other hand, the transmission after accumulating all images in a memory requires a long time in a case where a large number of documents are transmitted. An administrator of the communication equipment cannot check effectively regarding a case where a document is erroneously read inside out.

An aspect of the present invention provides a communication equipment and an image output system, which permit a user to check whether images were properly transmitted to transmission destinations.

### SUMMARY

According to an aspect of the present invention, a communication equipment comprises: an image reading unit that reads an image on a sheet; a read-image storage unit that stores the image read by the image reading unit; a first transmission unit that transmits the image stored in the read-image storage unit to an external equipment according to a transmission job; a monitor unit that determines whether or not the image is transmitted to the external equipment by the first transmission unit; a history-image storage unit that stores a history image, which is determined to be transmitted to the external equipment by the monitor unit; a history-printing instruction unit that gives an instruction to print a plurality of pages of the history image, stored in the history-image storage unit, on every one sheet according to a manipulation; and a printing unit that prints the plurality of pages of the history image on every one sheet on a basis of the instruction from the history-printing instruction unit.

According to another aspect of the present invention, a communication equipment comprises: an image reading unit that reads an image on a sheet; a read-image storage unit that stores the image read by the image reading unit; a first transmission unit that transmits the image stored in the read-image storage unit to an external equipment according to a transmission job; a monitor unit that determines whether or not the image is transmitted to the external equipment by the first transmission unit; a history-image storage unit that stores a history image, which is determined to be transmitted to the external equipment by the monitor unit; a printing unit that prints the history image stored in the history-image storage unit; a timer setting unit that sets a time period so that the printing unit prints the history image every time period; a timekeeping unit that counts the time period set by the timer setting unit; and a control unit that controls a plurality of pages of the history image to be printed on every one sheet and every time period counted by the timekeeping unit.

According to yet another aspect of the present invention, an image output system characterized by comprises: a communication equipment; and an information terminal device. The communication equipment comprises: an image reading unit that reads an image on a sheet; a read-image storage unit that stores the image read by the image reading unit; a first transmission unit that transmits the image stored in the read-image storage unit to an external equipment according to a transmission job; a monitor unit that determines whether or not the image is transmitted to the external equipment by the first transmission unit; and a history-image storage unit that stores a history image, which is determined to be transmitted to the external equipment by the monitor unit. The information terminal device comprises a history-printing instruction unit that gives an instruction to print a plurality of pages of the history image, stored in the history-image storage unit, on every one sheet, according to a manipulated. The communication equipment further comprises a printing unit that prints the plurality of pages of the history image on every one sheet on a basis of the instruction from the history-printing instruction unit.

According to still another aspect of the present invention, an image output system comprises: a communication equipment; and an information terminal device. The communication equipment comprises: an image reading unit that reads an image on a sheet; a read-image storage unit that stores the image read by the image reading unit; a first transmission unit that transmits the image stored in the read-image storage unit to an external equipment according to a transmission job; a monitor unit that determines whether or not the image is transmitted to the external equipment by the first transmission unit; a history-image storage unit that stores a history image, which is determined to be transmitted to the external equipment by the monitor unit; and a printing unit that prints the history image stored in the history-image storage unit. The information terminal device comprises: a timer setting unit that sets a time period so that the printing unit prints the history image every time period; a timekeeping unit that counts the time period set by the timer setting unit; and a control unit that controls a plurality of pages of the history image to be printed on every one sheet and every time period counted by the timekeeping unit.

### BRIEF DESCRIPTION OF THE DRAWINGS

FIG. 1 is an outside view showing a first illustrative aspect of a facsimile apparatus 1;

FIG. 2 is an enlarged view showing a manipulation portion 3 of a body case 2 of the facsimile apparatus 1;

FIG. 3 is a block diagram representing inside the facsimile apparatus 1;

FIG. 4 is a view showing transmitted images, which have been printed on a sheet P on a basis of various printing aspects set by a printing-aspect setting key 11;

FIG. 5 is a view showing transmitted images, which have been printed on a sheet P on the basis of printing aspects instead of FIG. 4, so that the size of the non-first pages of the transmitted images of each transmission job are smaller than the size of the first page;

FIG. 6 is a flow chart showing a process, which proceeds since depression of a transmission key 8 for FAX transmission, until a transmitted image subjected to the FAX transmission is stored in a transmitted-image saving RAM 24b;

FIG. 7 is a flow chart showing a printing process operation of the transmitted images;

FIG. 8 is a flow chart showing a data erasing process operation of the transmitted images;

FIG. 9 is a block diagram representing inside the facsimile apparatus 1 in the second illustrative aspect;

FIG. 10 is a flow chart showing the operation of a process for setting a time period by a timer setting unit 31 in the second illustrative aspect;

FIG. 11 is a block diagram schematically representing the image output system of a third illustrative aspect;

FIG. 12 is a flow chart showing a printing process operation of transmitted images in the third illustrative aspect;

FIG. 13 is a flow chart showing a data erasing process operation of the transmitted images in the third illustrative aspect;

FIG. 14 is a block diagram schematically representing the image output system of a fourth illustrative aspect;

FIG. 15 is a flow chart showing an operation of a process for setting a time period by a timer setting unit 31 in the fourth illustrative aspect;

FIG. 16 is a flow chart representing an operation of a process for selecting transmitted images to-be-erased by the printing-aspect setting key 11; and

FIG. 17 is a flow chart representing an operation of a process for selecting transmitted images to-be-erased by a keyboard 50 and a mouse 51.

### DETAILED DESCRIPTION

[First Illustrative Aspect]

(External Appearance of Communication Equipment)

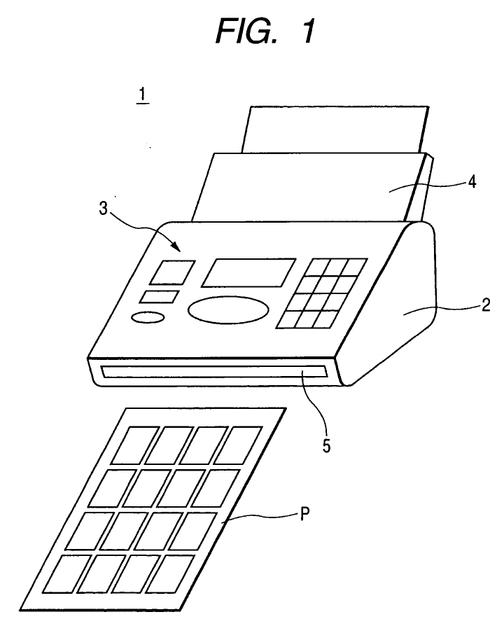

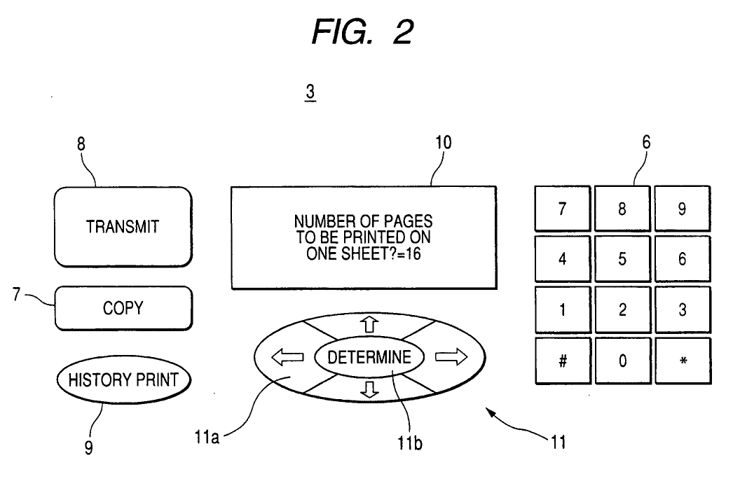

The external appearance of a facsimile apparatus as the communication equipment of the present invention will be described with reference to FIG. 1. FIG. 1 is an outside view showing the first illustrative aspect of the facsimile apparatus 1. FIG. 2 is an enlarged view showing the manipulation portion 3 of the body case 2 of the facsimile apparatus 1.

The facsimile apparatus 1 is connected to a telephone line not shown, and the manipulation portion 3 is disposed on the upper surface of the body case 2. There are also provided a document feeder 4 on which a document is placed when the document not shown is to be copied or to be FAX-transmitted to anyone, and a paper discharge port 5 through which the copied or FAX-transmitted document is discharged. As shown in FIG. 2, the manipulation portion 3 comprises dial keys 6 as a password input unit to input a telephone number of a destination or a password to be explained later; a copy key 7, which is depressed when the copy of the document is to be started; a transmission key 8, which serves to FAX-transmit the document to the destination having the telephone number inputted by the dial keys 6; a history print key 9, which is a history-image-print instruction unit that is depressed for performing N-in-one printing (N: integer of at least one) in which a plurality of transmitted images as the history images of a plurality of documents FAX-transmitted up to the present are printed on one sheet P; a liquid crystal panel 10, which is a display unit to display the printing aspect of the transmitted images subjected to the FAX transmissions printing of which starts on the depression of the history print key 9; and a printing-aspect setting key 11 as a printing-aspect setting unit and selection unit comprising selection keys 11a to select and set the printing aspect of the transmitted images as is displayed on the liquid crystal panel 10 and a determination button 11b that is depressed for determining the printing aspect of the transmitted images as has been selected and set with the selection keys 11a.

(Mutual Relations Among Various Constituents of Communication Equipment)

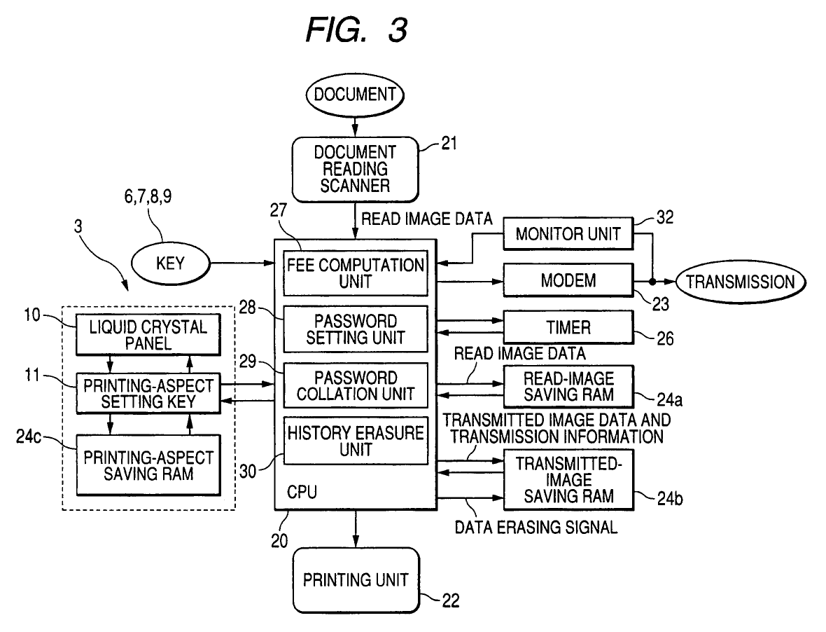

The mutual relations among the various constituents of the facsimile apparatus 1 will be described with reference to the block diagram of FIG. 3. FIG. 3 is the block diagram representing inside the facsimile apparatus 1.

As shown in FIG. 3, the facsimile apparatus 1 comprises a CPU 20, a document reading scanner 21, a read-image saving RAM 24a, a printing unit 22, a MODEM 23, a transmitted-image saving RAM 24b, a printing-aspect saving RAM 24c, a timer 26 and a manipulation portion 3. The CPU 20 is a control unit to be explained later. It operates in accordance with various programs. The document reading scanner 21 is an image reading unit to read the image of a document P. The read-image saving RAM 24a is a read-image storage unit that stores the read image read by the document reading scanner 21. The printing unit 22 prints the read image stored in the read-image saving RAM 24a. The MODEM 23 is a first transmission unit that converts a digital signal, which is processed by a computer, into an analog signal as a telephonic voice and then sent to an external equipment through an analog telephone line (not shown). The transmitted-image saving RAM 24b is a history-image storage unit that stores an image that has become a transmitted image in such a way that the read image stored in the read-image saving RAM 24a has been FAX-transmitted from the MODEM 23. FAX transmission information items, such as the telephone number of a transmission destination, the name of the transmission destination, a page number and a transmission fee are stored. The printing-aspect saving RAM 24c is a printing-aspect storage unit that temporarily stores the setting contents of the printing aspect of such transmitted images temporarily stored in the transmitted-image saving RAM 24b. In a case where the transmitted images are printed by the printing unit 22 the setting contents include, the setting contents include setting contents for erasing the transmitted images (to be explained later) from the transmitted-image saving RAM 24b and the setting content of a password necessary for erasing the transmitted images (to be explained later). The timer 26 is a timekeeping unit that counts time periods. The manipulation portion 3 comprises the dial keys 6, copy key 7, transmission key 8, history print key 9, liquid crystal panel 10 and printing-aspect setting key 11 as stated before. The CPU 20 comprises a fee computation unit 27, a password setting unit 28, a password collation unit 29, and a history erasure unit 30.

The MODEM 23 is furnished with a monitor unit 32, and the monitor unit 32 monitors whether or not the read image turned into the digital signal has been transmitted from the MODEM 23 toward the analog telephone line. Upon deciding that the read image has been FAX-transmitted, the monitor unit 32 sends the digital signal of the transmitted image subjected to the FAX transmission to the CPU 20. The CPU 20 having received the digital signal from the monitor unit 32 stores the transmitted image in the transmitted-image saving RAM 24b. A processing operation, from the FAX transmission of the read image based on the depression of the transmission key 8 until the transmitted image subjected to the FAX transmission is stored in the transmitted-image saving RAM 24b, will be described in detail later.

(Printing Aspect of Transmitted Images)

The printing-aspect setting key 11 explained above is capable of setting the printing aspect of the transmitted images, which will be subjected to the N-in-one printing by the printing unit 22 upon the depression of the history print key 9. The printing aspects stated below can be set by the various settings of the printing aspects.

<Settings of N-Value in N-in-One Printing>

The value N of the transmitted images to be subjected to the N-in-one printing can be set by manipulating the printing-aspect setting key 11. That is, there is provided the printing aspect in which the number of pages of the transmitted images to be printed on one sheet P can be set. Due to such a printing aspect, in a case where a user who uses the facsimile apparatus 1 is an elderly person or the like user who has difficulty looking at fine characters or images, 2-in-one printing or 4-in-one printing is set. Thus, the number of pages of the transmitted images to be printed on one sheet P decreases, and a size to one page of the transmitted image can be enlarged, so that even the user who has difficulty looking at the fine characters or images can satisfactorily check the contents and image qualities of the transmitted images. On the other hand, in a case where a user who has no problem even with fine characters or images uses the facsimile apparatus 1, 16-in-one printing or 8-in-one printing is set. Thus, in a situation where the number of pages of the transmitted images to be printed or the number of transmission jobs is larger, the amount of sheets P on which the transmitted images are to be printed can be reduced. Simultaneously, it is possible to shorten a time period for printing the transmitted images and a time period for checking the respective transmitted images formed on the sheets P. An administrator can easily check later, if a person who is unaccustomed to manipulations performed the FAX transmission properly.

<Selection of Image or Images to be Printed, in Transmitted Images transmitted by Each Transmission Job>

There is provided a printing aspect, in which whether only the first (head) page of the transmitted images transmitted by each transmission job is to be printed or all the pages of them are to be printed, is made selectable by manipulating the printing-aspect setting key 11. Due to such a printing aspect, in a case where the destinations of FAX transmissions are to be checked, but the contents of the transmitted images do not need to be checked, the amount of sheets P can be saved by the setting in which only the first page of the transmitted images transmitted by each transmission job is to be printed. Simultaneously, it is possible to shorten a time period for printing the transmitted images and a time period for checking the respective transmitted images formed on the sheets P. In a case where, not only the destinations of the FAX transmissions, but also the contents of the transmitted images need to be checked whether the transmitted images were properly transmitted over all the pages can be checked by printing the transmitted images of all the pages of each transmission job. A process in which one image or more images are transmitted by depressing the transmission key 8 once shall be called the “transmission job”.

<Setting of Size of Non-first Pages of Transmitted Images Transmitted by Each Transmission Job>

There is provided a printing aspect in which, whether the images of the non-first pages of the transmitted images transmitted by each transmission job are to be printed with a size equal to the size of the image of the first page or with a size smaller than the size of the image of the first page, in the case of the setting where all the pages of the transmitted images transmitted by each transmission job are to be set, is made selectable by manipulating the printing-aspect setting key 11. Due to such a printing aspect, in a case where an elderly person or the like who has difficulty looking at fine characters or images wants to check the transmitted images over all the pages of each transmission job, he/she can easily check whether the transmitted images were properly transmitted over all the pages of the transmitted images of each transmission job when the transmitted images of each transmission job except the head page are printed with the size equal to that of the transmitted image of the first page of each transmission job. In a case where, as in cover letters, the rough contents of the transmitted images of each transmission job can be grasped from the transmitted image of the first page of each transmission job, are fine contents need not be grasped, the amount of sheets P can be saved, when the transmitted images of the non-first pages of each transmission job are printed with the size smaller than that of the transmitted image of the first page of each transmission job.

<Setting of Term in which Transmitted Images to be Printed were Transmitted>

There is provided a printing aspect in which a time period can be set by manipulating the printing-aspect setting key 11. Due to such a printing aspect, the term of the transmitted images to be checked can be set as desired by a user. For example, a term including images transmitted from yesterday or last week until today can be set. Also, the start of the term of the transmitted images to be checked can be set by the user, proper transmissions. For example, a term beginning tomorrow, next week or the like predetermined time till the next printing of the transmitted images can be set. By way of example, when a time period is set in conformity with the closing time of a shop, all data transmitted during one day can be efficiently checked at the business end of that day.

<Setting of Term as to which Transmission Fees of Transmitted Images are Computed>

There is provided a printing aspect in which the start time of the term of the transmissions of the transmitted images, whose transmission fees are to be computed and printed, can be set by manipulating the printing-aspect setting key 11. Due to such a printing aspect, it is possible to check the transmission fees of the transmitted images in an amount or within the term as desired by a user, such as in units of the transmitted images of each transmission job, in units of the transmitted images transmitted in one day, or in units of the transmitted images transmitted in one week.

<Setting of Header Information>

There is provided a printing aspect in which the transmission destinations or telephone numbers of the transmitted images subjected to transmissions, and page numbers or the like can be set as the header information items of the transmitted images by manipulating the printing-aspect setting key 11. Due to such a printing aspect, it is possible to check the transmission destinations or telephone numbers of the transmitted images subjected to the transmissions, and the page numbers or the like. It is therefore possible to check whether images free from any image quality defect were transmitted to the proper destinations without any transmission trouble.

(Setting of Password)

A password can be set by manipulating the dial keys 6 as the password input unit. The password inputted by the dial keys 6 is stored in the printing-aspect saving RAM 24c by that password setting unit 28 of the CPU 20, which functions as the password setting unit.

(Operations of Processes for Setting Printing Aspects)

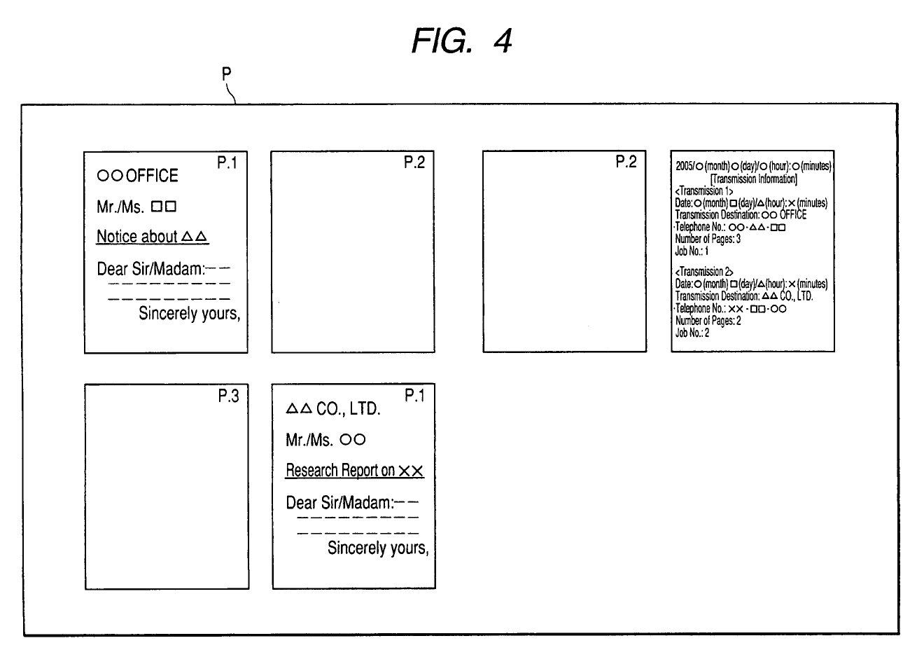

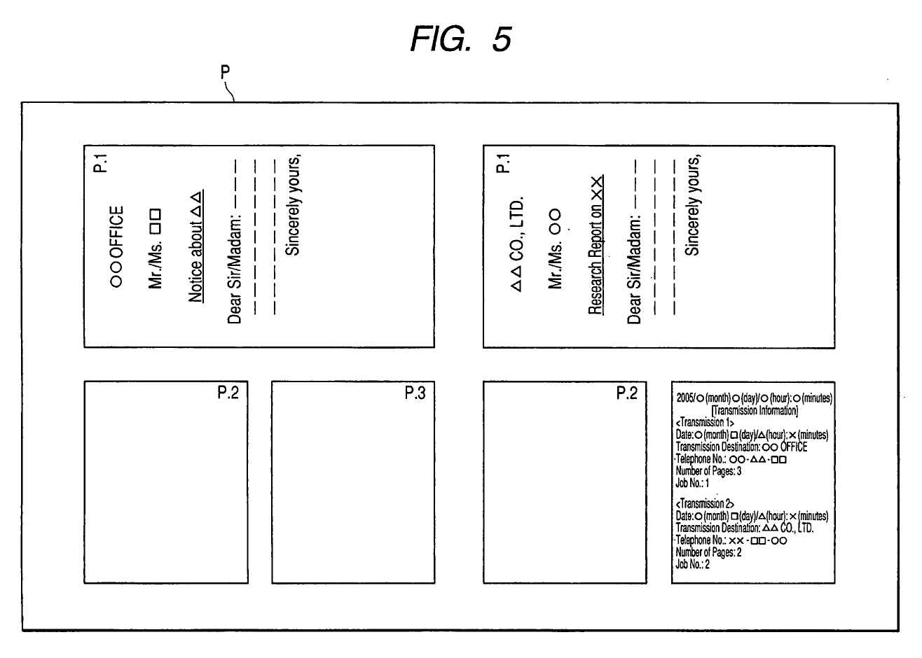

The operations of the setting processes for setting the above printing aspects by the printing-aspect setting key 11 will be described with reference to the drawings. FIG. 4 is a view showing transmitted images, which have been printed on the sheet P on the basis of the foregoing printing aspects set by the printing-aspect setting key 11. FIG. 5 is a view showing transmitted images, which have been printed on the sheet P on the basis of the printing aspects set instead of those set in FIG. 4, so that the size of the non-first pages of the transmitted images of each transmission job may become smaller than the size of the first page.

A user depresses keys of up-and-down directions among the selection keys 11a of the printing-aspect setting key 11 shown in FIG. 2, thereby selecting items whose settings are to be altered. The “items” termed here are the setting of the N-value of the N-in-one printing, the selection of an image to-be-printed in the transmitted images transmitted by each transmission job, the setting of the size of the non-first pages of the transmitted images transmitted by each transmission job, the setting of a term in which the transmitted images to be printed were transmitted, the setting of a term as to which the transmission fees of the transmitted images are to be computed, the setting of header information, the setting of a password, and the selection of the transmitted image to be erased. When the selection keys 11a are depressed, these items are successively displayed on the liquid crystal panel 10.

<Operation of Process for Setting N-Value of N-in-One Printing>

In a case where the setting of the N-value of the N-in-one printing has been selected by depressing the keys of the up-and-down directions among the selection keys 11a, an indication, such as “Number of Pages to be Printed on One Sheet?=16” is displayed on the liquid crystal panel 10 as shown in FIG. 2. When the user depresses the keys of right-and-left directions among the selection keys 11a while watching the liquid crystal panel 10, he/she can alter a numeral (here, “16”) shown on the liquid crystal panel 10. In a case, for example, where the numeral displayed on the liquid crystal panel 10 is altered to “8” and where the determination button 11b is depressed, there is performed so-called 8-in-one printing in which the transmitted images corresponding to 8 pages are printed on one sheet P as shown in FIG. 5. In a case where the number of the pages of the transmitted images transmitted by one transmission job is large or where the images were FAX-transmitted many times, naturally all the transmitted images to be printed cannot always be printed on one sheet P.

<Operation of Process for Selecting Images to-be-Printed in Transmitted Images transmitted by Each Transmission Job>

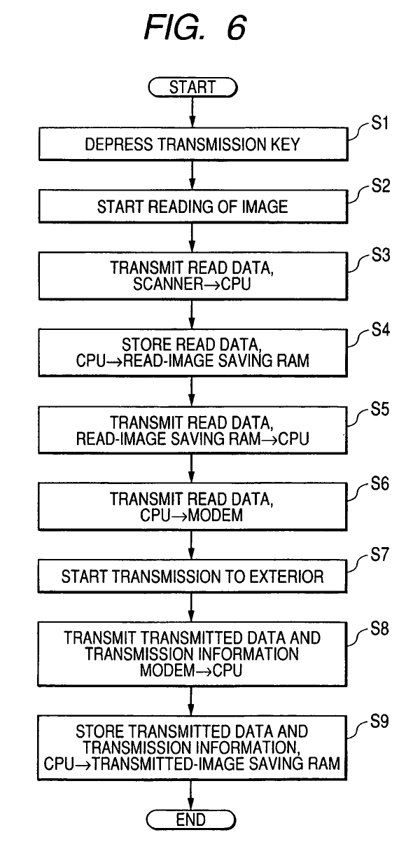

In a case where the selection of images to-be-printed of the transmitted images transmitted by each transmission job has been selected by depressing the keys of the up-and-down directions among the selection keys 11a, an indication, such as “Only First Page to be Printed?” is displayed on the liquid crystal panel 10. When the user depresses the keys of the right-and-left directions among the selection keys 11a while watching the liquid crystal panel 10, the display of the liquid crystal panel 10 is changed to a display, such as “All Pages to be Printed?”. When the user depresses the determination button lib with the display of the liquid crystal panel 10 being “All Pages to be Printed?”, he/she subsequently sets the size of the non-first pages of the transmitted images transmitted by each transmission job. On this occasion, an indication, such as “All Pages with Same Size?”, is displayed on the liquid crystal panel 10. When the user depresses the keys of the right-and-left directions among the selection keys 11a while watching the liquid crystal panel 10, the display of the liquid crystal panel 10 is changed to a display, such as “Non-First Pages with Smaller Size?” When the user depresses the determination button 11b with the display of the liquid crystal panel 10 being “Non-First Pages with Smaller Size?”, the non-first pages of the transmitted images of each transmission job are printed to be smaller than the first page, as shown in FIG. 6.

<Operation of Process for Setting Term in which Transmitted Images to-be-Printed were Transmitted>

In a case where the setting of a term in which the transmitted images to be printed were transmitted has been selected by depressing the keys of the up-and-down directions among the selection keys 11a, an indication, such as “Since When Images to be Printed?=One Day Before”, is displayed on the liquid crystal panel 10. When the user depresses the keys of the right-and-left directions among the selection keys 11a while watching the liquid crystal panel 10, the display of a time on the liquid crystal panel 10 (here, “One Day Before”) is changed to a display, such as “One Week Before”, “One Day After” or “One Week After”. When the user depresses the determination button 11b with the display of the liquid crystal panel 10 being “Since When Images to be Printed?=One Day After”, the timer 26 starts by the CPU 20, and the transmitted images, which were FAX-transmitted in the term since one day after the start of the timer 26, till the printing of the transmitted images, and which have been stored in the transmitted-image saving RAM 24b, are printed by the printing unit 22.

<Operation of Process for Setting Term as to which Transmission Fees of Transmitted Images are to be Computed>

In a case where the setting of a term in which the transmitted images whose transmission fees are to be computed were transmitted has been selected by depressing the keys of the up-and-down directions among the selection keys 11a, an indication, such as “Since When Transmission Fees to be Computed?=One Day Before” is displayed on the liquid crystal panel 10. When the user depresses the keys of the right-and-left directions among the selection keys 11a while watching the liquid crystal panel 10, the display of a time on the liquid crystal panel 10 (here, “One Day Before”) is changed to a display, such as “One Week Before”, “One Day After” or “One Week After”. When the user depresses the determination button 11b with the display of the liquid crystal panel 10 being “Since When Transmission Fees to be Computed?=One Day After”, the timer 26 starts by the CPU 20, and the transmission fees of the transmitted images, which were FAX-transmitted in the term from one day after the start of the timer 26 until the printing of the transmitted images and which have been stored in the transmitted-image saving RAM 24b, are computed by the fee computation unit 27 and are printed on the first page or last page of the printed transmitted images.

<Operation of Process for Setting Header Information>

In a case where the setting of header information has been selected by depressing the keys of the up-and-down directions among the selection keys 11a, an indication, such as “Header Information?=OFF” is displayed on the liquid crystal panel 10. When the user depresses the keys of the right-and-left directions among the selection keys 11a while watching the liquid crystal panel 10, ON/OFF displayed on the liquid crystal panel 10 (here, “OFF”) can be altered. When the user depresses the determination button 11b after “OFF” displayed on the liquid crystal panel 10 has been altered to “ON”, the header information items, such as the transmission destinations and their telephone numbers, the page numbers, etc. of the transmitted images, are printed together with these transmitted images as shown in FIGS. 4 and 5.

(Processing Operation which Proceeds Since Depression of Transmission Key till Storage of Transmitted Image)

A processing operation, which proceeds from when a read image is FAX-transmitted by the depression of the transmission key 8 until the transmitted image subjected to the FAX transmission is stored in the transmitted-image saving RAM 24b, will be described with reference to FIG. 6. FIG. 6 is a flow chart showing the process, which proceeds from the depression of the transmission key 8 for the FAX transmission until the transmitted image subjected to the FAX transmission, is stored in the transmitted-image saving RAM 24b.

A document to be FAX-transmitted is set on the document feeder 4 of the facsimile apparatus 1, and the transmission key 8 is depressed (S1). The facsimile apparatus 1 whose transmission key 8 has been depressed starts the reading of the image of the set document by the document reading scanner 21 (S2). The document reading scanner 21, which has started the reading of the image, converts the data of the read image into FAX-transmitting data and successively transmits the resulting data to the CPU 20 (S3). The CPU 20, which has started the reception of the data of the read image, transmits the data to the read-image saving RAM 24a and temporarily stores the data therein (S4). The read-image saving RAM 24a, which has received the data from the CPU 20 and has stored the data therein, transmits the data to the CPU 20 again (S5); and the CPU 20 transmits the data received from the read-image saving RAM 24a to the MODEM 23 (S6). When it has been verified by the monitor unit 32 that the read image data transmitted to the MODEM 23 have started transmitting from the MODEM 23 to the analog telephone line (S7), the MODEM 23 transmits the header information of the transmitted image to the CPU 20 together with the data of the transmitted image (S8). The data and header information of the transmitted image as have been transmitted to the CPU 20 are transmitted to the transmitted-image saving RAM 24b and are stored therein (S9).

(Operation of Process for Setting Password)

In a case where the setting of a password has been selected by depressing the keys of the up-and-down directions among the selection keys 11a, an indication, such as “Password Input” is displayed on the liquid crystal panel 10. When the user inputs the password by depressing the dial keys 6 while watching the liquid crystal panel 10, the password can be displayed on the liquid crystal panel 10. When the user depresses the determination button 11b, the inputted password is stored in the printing-aspect saving RAM 24c by the password setting unit 28.

(Operation of Process for Printing Transmitted Images)

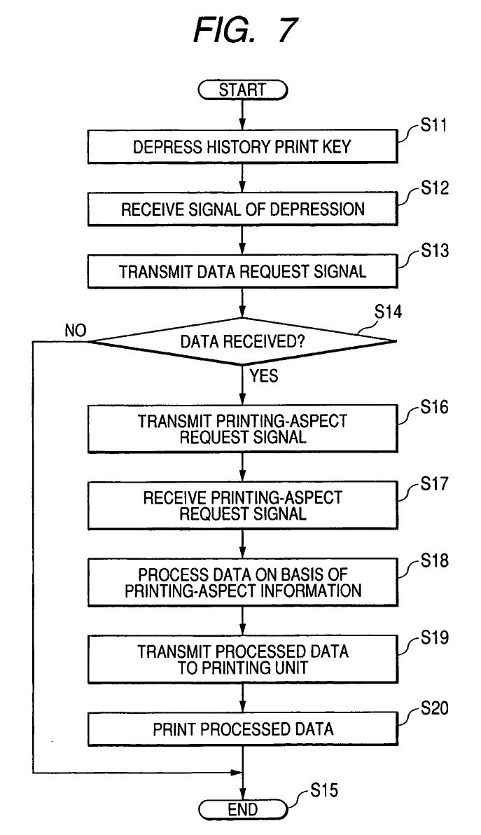

The printing operation of transmitted images will be described with reference to FIG. 7. FIG. 7 is a flow chart showing the printing process operation of the transmitted images.

The history print button 9 is depressed by the user (S11). When the CPU 20 has received a signal, which indicates the depression of the history print button 9 (S12), the CPU 20 sends a data request signal to the transmitted-image saving RAM 24b (S13). The CPU 20, having sent the data request signal, determines whether or not the transmitted image data and the data of the header information of the transmitted images have been received from the transmitted-image saving RAM 24b (S14). In a case where the CPU 20 has not received the transmitted image data and the data of the header information of the transmitted images (S14: “No”), it is deemed that the transmitted images are not stored in the transmitted-image saving RAM 24b, and the printing process ends (S15). In a case where the CPU 20 has received the transmitted image data and the data of the header information of the transmitted images (S14: “Yes”), the CPU 20 sends a printing-aspect request signal to the printing-aspect saving RAM 24c (S16). When the CPU 20 has received the information of the printing aspect, set by the printing-aspect setting process explained before, from the printing-aspect saving RAM 24c (S17), the CPU 20 processes the transmitted image data and the data of the header information of the transmitted images on the basis of the received printing-aspect information (S18). The transmitted image data and the data of the header information of the transmitted images as have been worked, are transmitted to the printing unit 22 (S19), and the N-in-one printing of the transmitted images is performed by the printing unit 22 on the basis of the transmitted data (S20). After the transmitted images have been printed, this process ends (S15).

The transmitted images subjected to the FAX transmissions can be printed by depressing the history print key 9. Therefore, even in a case where the read images are directly FAX-transmitted at the time, for example, when a large quantity of documents are to be FAX-transmitted quickly, whether the images free from image quality defects have been properly transmitted can be checked. Since the transmitted images subjected to the FAX transmissions can be printed merely by depressing the history print key 9, even a user who is unaccustomed to the manipulations of the facsimile apparatus 1 can easily check whether FAX images properly printed could be transmitted or if they could be transmitted to proper destinations.

(Operation of Process for Erasing Data of Transmitted Images)

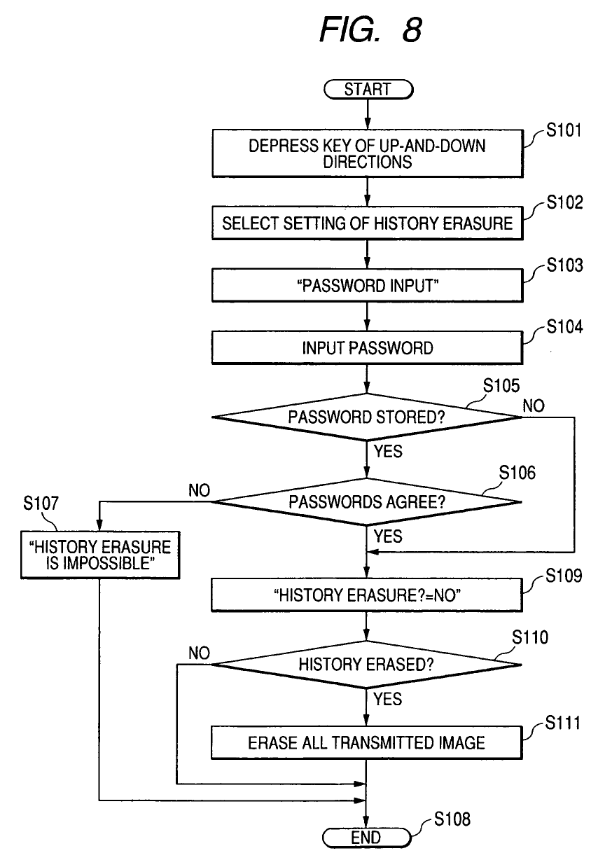

The operation of a process for erasing the data of the transmitted images stored in the transmitted-image saving RAM 24b will be described with reference to FIG. 8. FIG. 8 is a flow chart showing the data erasing process operation of the transmitted images.

The keys of the up-and-down directions among the selection keys 11a are depressed by the user (S101). When the setting of history erasure has been selected (S102), an indication, such as “Password Input” is displayed on the liquid crystal panel 10 (S103). When the user has inputted a password by depressing the dial keys 6 while watching the liquid crystal panel 10 (S104), whether or not a password is stored in the printing-aspect saving RAM 24c is determined by the CPU 20 (S105). Subject to the decision that the password is stored in the printing-aspect saving RAM 24c (S105: “Yes”), whether or not the password inputted by the dial keys 6 and the password stored in the printing-aspect saving RAM 24c agree is collated by the password collation unit 29 (S106). When the two passwords do not agree (S106: “No”), an indication, such as “Password is Wrong” or “History Erasure is Impossible” is displayed (S107), and this process ends (S108). When the two passwords agree (S106: “Yes”), an indication, such as “History Erasure?=NO” is displayed (S109). When the user depresses the keys of the right-and-left directions among the selection keys 11a while watching the liquid crystal panel 10, he/she can alter YES/NO (here, “NO”) displayed on the liquid crystal panel 10. When the user alters “NO” displayed on the liquid crystal panel 10 to “YES” and then depresses the determination button 11b (S110: “Yes”), all the transmitted images stored in the transmitted-image saving RAM 24b are erased by the history erasure unit 30 (S111). After the transmitted images have been erased, this process ends (S108). On the other hand, when the user depresses the determination button 11b without altering “NO” displayed on the liquid crystal panel 10 (S110: “No”), this process ends (S107). When it has been determined at the step S104 that the password is not stored in the printing-aspect saving RAM 24c (S105: “No”), the routine shifts to the steps S109, et seq. When the user alters “NO” on the liquid crystal panel 10 displaying “History Erasure?=NO”, to “YES” and then depresses the determination button 11b (S110: “Yes”), all the transmitted images stored in the transmitted-image saving RAM 24b are erased by the history erasure unit 30 (S111). Due to such processing, when the administrator sets the password, he/she can be prevented from failing to check the transmitted image, for the reason that the data of the transmitted image are erased from the transmitted-image saving RAM 24b when any user other than the administrator has transmitted the image.

When the dial keys 6, the printing-aspect setting key 11 or the like have not been depressed for a predetermined time period between the setting in each of the various settings of the illustrative aspect, the display of the liquid crystal panel 10 is changed to the screen display of the initial setting.

[Second Illustrative Aspect]

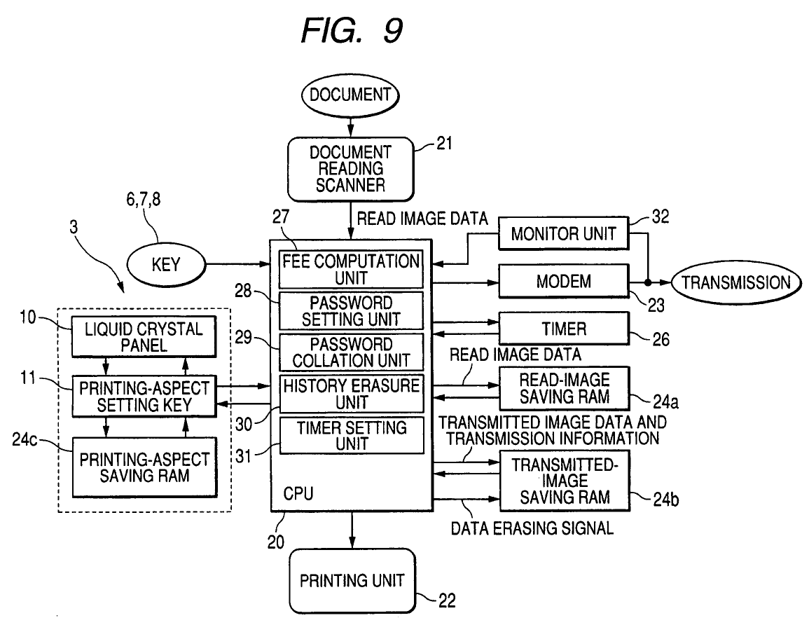

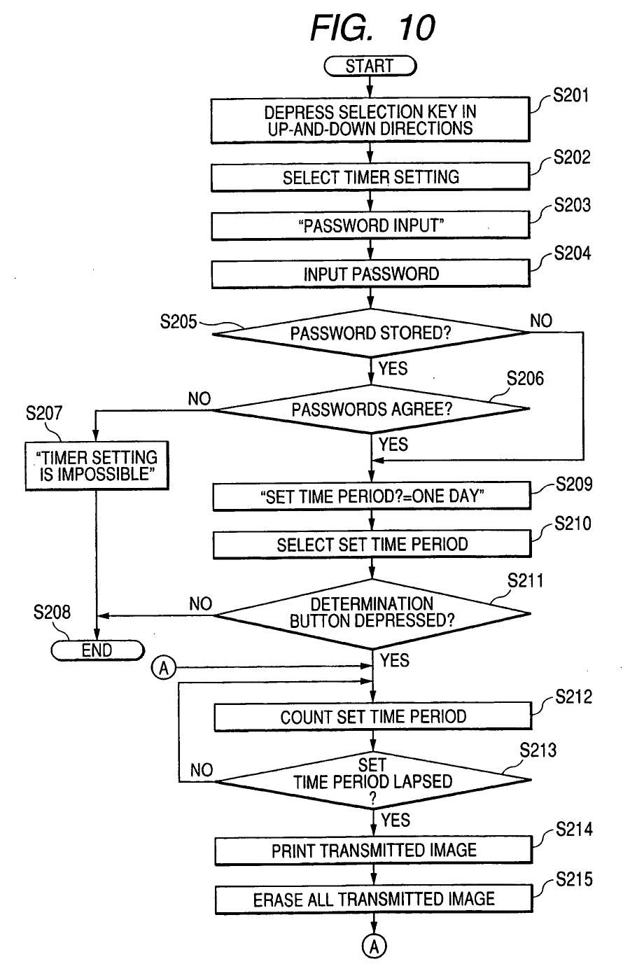

A communication equipment according to the second illustrative aspect of the present invention will be described with reference to the drawings. Incidentally, component parts corresponding to those of the first illustrative aspect will be assigned identical reference numerals and signs, and the repeated description of the first illustrative aspect shall be omitted. FIG. 9 is a block diagram representing inside the facsimile apparatus 1 in the second illustrative aspect. FIG. 10 is a flow chart showing the operation of a process for setting a time period by a timer setting unit 31 in the second illustrative aspect.

In this illustrative aspect, the history print key 9 as the history-printing instruction unit as shown in FIG. 2 is not disposed, but as shown in FIG. 9, the time period to be counted by the timer 26 is set by the timer setting unit 31 as a timer setting unit, so as to print transmitted images every set time period. After the transmitted images have been printed, the data of the printed transmitted images are erased from the transmitted-image saving RAM 24b by the history erasure unit 30.

(Operation of Process for Printing Transmitted Images on basis of Timer Setting)

As shown in FIG. 10, the keys of the up-and-down directions among the selection keys 11a are first depressed by a user (S201). When the setting of the timer has been selected (S202), an indication, such as “Password Input” is displayed on the liquid crystal panel 10 (S203). When the user inputs a password by depressing the dial keys 6 while watching the liquid crystal panel 10 (S204), whether or not a password is stored in the printing-aspect saving RAM 24c is determined by the CPU 20 (S205). Subject to the decision that the password is stored in the printing-aspect saving RAM 24c (S205: “Yes”), whether or not the password inputted by the dial keys 6 and the password stored in the printing-aspect saving RAM 24c agree is collated by the password collation unit 29 (S206). When the two passwords do not agree (S206: “No”), an indication, such as “Password is Wrong” or “Timer Setting is Impossible”, is displayed (S207), and this process ends (S208). When the two passwords agree (S206: “Yes”), an indication, such as “Set Time Period?=One Day”, is displayed (S209). When the user depresses the keys of the right-and-left directions among the selection keys 11a while watching the liquid crystal panel 10, he/she can alter the time period displayed on the liquid crystal panel 10 (here, “one day”) to “one hour” or “one week” (S210). When the user depresses the determination button 11b (S211: “Yes”), the timer setting unit 31 causes the timer 26 to count the set time period (S212). When the user has not depressed the determination button 11b (S211: “No”), this process ends (S209). When the set time period has not lapsed (S213: “No”) the counting by the timer 26 is continued. When the set time period has lapsed (S213: “Yes”), the transmitted images are printed on the basis of the printing aspect set by the printing-aspect setting key 11 (S214). When the transmitted images have been printed, the data of the printed transmitted images are entirely erased from the transmitted-image saving RAM 24b (S215). The routine returns to the step S212, and the set time period starts counting by the timer 26 again. When it has been determined at the step S205 that the password is not stored in the printing-aspect saving RAM 24c (S205: “No”), the routine shifts to the steps S209, et seq., and the timer setting is performed. Before the operation of this process is performed from the step S201 again, the steps S212 to S215 are repeated. In a case where this process operation is performed from the step S201 again, it is performed with a new set time period, and the steps S212 to S215 are repeated with the new set time period before this process operation is subsequently performed from the step S201.

Due to such a process, the transmitted images subjected to the FAX transmissions can be printed. Therefore, even in a case where the read images are directly FAX-transmitted at a time, for example, when a large quantity of documents are to be FAX-transmitted quickly, whether the images free from image quality defects have been properly transmitted can be checked. The transmitted images can be automatically printed by the timer 26, so that when the timer 26 is set in conformity with, for example, the closing time of a shop, all data transmitted during one day can be efficiently checked at the business end of that day automatically every day. Even when a user who is unaccustomed to the manipulations of the facsimile apparatus 1 does not perform the manipulations, the transmitted images can be automatically printed by the timer setting unit 31. When an administrator sets the password, any other user except the administrator can be prevented from freely setting the timer. In addition, even when the administrator does not input the password every operation, the transmitted images can be erased.

[Third Illustrative Aspect]

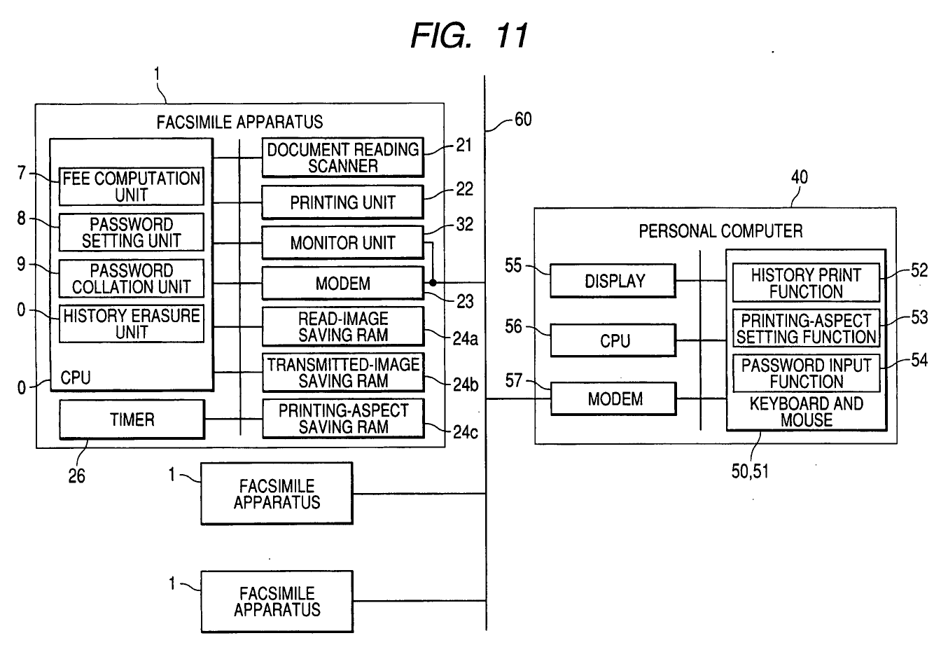

An image output system according to the third illustrative aspect of the present invention will be described with reference to the drawings. Incidentally, component parts corresponding to those of the first illustrative aspect and second illustrative aspect will be assigned identical reference numerals and signs, and the repeated descriptions of the first illustrative aspect and second illustrative aspect shall be omitted. FIG. 11 is a block diagram schematically the image output system of the third illustrative aspect.

(Mutual Relations among Various Constituents of Image Output System)

In this illustrative aspect, as shown in FIG. 11, a plurality of facsimile apparatuses 1 as communication equipments are connected to a personal computer 40 (“PC 40”) as an information terminal device, through a network 60; and information, such as image data, can be transmitted and received. A display 55, which is a display unit; a keyboard 50 and a mouse 51, which correspond to the manipulation portion 3 in the first illustrative aspect or second illustrative aspect; and a CPU 56, which operates in accordance with various programs, are disposed on the side of the PC 40.

The keyboard 50 and the mouse 51 provide a history print function 52 as a history-printing instruction unit, a printing-aspect setting function 53 as a printing-aspect setting unit, and a password input function 54 as a password input unit. When the keyboard 50 and the mouse 51 are employed, a manipulation for printing the transmitted images, the settings of the various printing aspects explained in the first illustrative aspect and second illustrative aspect, and a manipulation for inputting a password can all be performed while the display 55 is viewed. The information of the printing aspect or the password, which has been set or inputted by the keyboard 50 and the mouse 51, is transmitted from a MODEM 57 as the second transmission unit of the PC 40 to each of the facsimile apparatuses 1 so as to be stored in the printing-aspect saving RAM 24c as a printing-aspect storage unit.

(Operation of Process for Printing Transmitted Images)

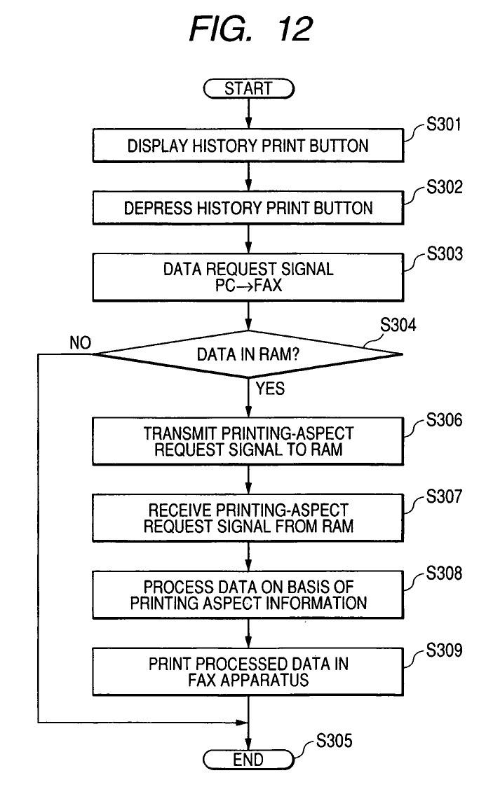

The printing operation of the transmitted images will be described with reference to FIG. 12. FIG. 12 is a flow chart showing the printing process operation of the transmitted images in the third illustrative aspect.

When the keyboard 50 or mouse 51 of the PC 40 is manipulated by a user, a history print button is displayed on the display 55 by the history print function 52 (S301). When the displayed history print button is depressed (S302), a data request signal is transmitted from the CPU 56 of the PC 40 through the CPU 20 of each of the facsimile apparatuses 1 to the transmitted-image saving RAM 24b as a history image storage unit (S303). The CPU 20 of the facsimile apparatus 1 determines whether or not the transmitted-image saving RAM 24b having received the data request signal has received transmitted image data and the data of the header information of the transmitted images (S304). When the CPU 20 determines that the transmitted image data and the data of the header information of the transmitted images have not been received (S304: “No”), it is deemed that the transmitted images are not stored in the transmitted-image saving RAM 24b, and the printing process ends (S305). When the CPU 20 determines that the transmitted image data and the data of the header information of the transmitted images have been received (S304: “Yes”), this CPU 20 sends a printing-aspect request signal to the printing-aspect saving RAM 24c as a printing-aspect storage unit within the facsimile apparatus 1 (S306). When the CPU 20 has received the information of the printing aspect set by the printing-aspect setting function 53 from the printing-aspect saving RAM 24c (S307), the CPU 20 processes the transmitted image data and the data of the header information of the transmitted images on the basis of the received printing-aspect information (S308). The transmitted image data and the data of the header information of the transmitted images as have been worked, are subjected to the printing of the transmitted images by the printing unit 22 as a printing unit (S309). After the transmitted images have been printed, this process ends (S305).

The transmitted images subjected to the FAX transmissions can be printed by activating the history print button on the display 55 of the PC 40 by the keyboard 50 or the mouse 51. Therefore, even in a case where the read images are directly FAX-transmitted at the time, for example, when a large quantity of documents are to be FAX-transmitted quickly, whether the images free from image quality defects were properly transmitted can be checked. Even a user who is unaccustomed to the manipulations of the facsimile apparatus 1 or the PC 40 can easily check whether FAX images properly printed could be transmitted or whether FAX images could be transmitted to proper destinations. Since the PC 40 is provided with the history print function 52, the user can print the transmitted images without going to a place where the facsimile apparatus 1 is installed.

(Operation of Process for Erasing Data of Transmitted Images)

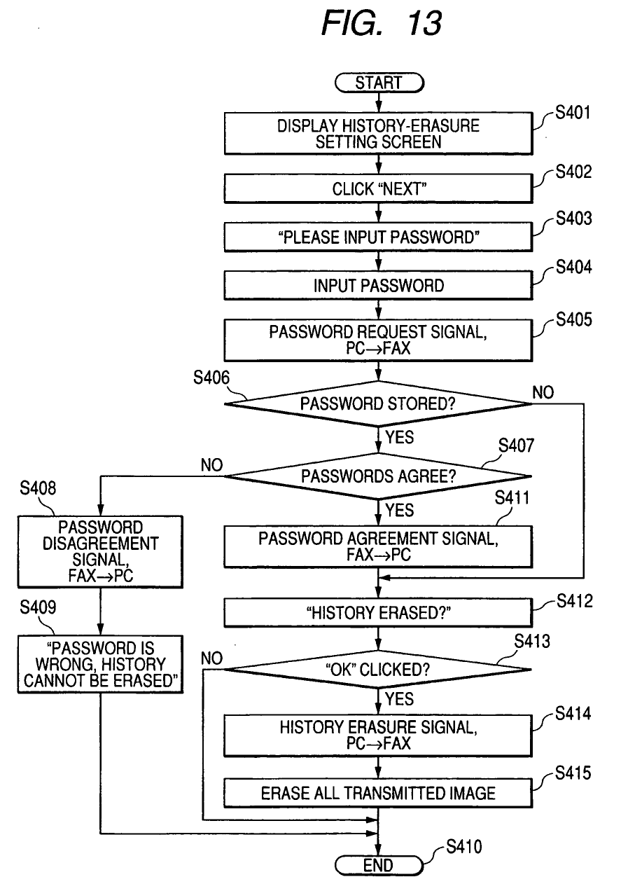

The operation of a process for erasing the data of the transmitted images stored in the transmitted-image saving RAM 24b will be described with reference to FIG. 13. FIG. 13 is a flow chart showing the data erasing process operation of the transmitted images in the third illustrative aspect.

When the keyboard 50 or mouse 51 of the PC 40 is manipulated by the user, a history-erasure setting screen is displayed on the display 55 by the printing-aspect setting function 53 (S401). When the “Next” button or the like is clicked (S402), an indication, such as “Please Input Password”, is displayed on the display 55 by the password input function 54 (S403). When the user inputs a password by manipulating the keyboard 50 while watching the display 55 (S404), a password request signal is transmitted from the MODEM 57 of the PC 40 to the printing-aspect saving RAM 24c through the CPU 20 of each facsimile apparatus 1 (S405). Subject to the decision that a password is stored in the printing-aspect saving RAM 24c of the facsimile apparatus 1 (S406: “Yes”), whether or not the password inputted by the keyboard 50 and the password stored in the printing-aspect saving RAM 24c agree is collated by the password collation unit 29 (S407). When the two passwords do not agree (S407: “No”), a password disagreement signal is transmitted from the MODEM 23 of the facsimile apparatus 1 to the PC 40 (S408), and an indication, such as “Password is Wrong, and History Cannot be Erased”, is displayed on the display 55 of the PC 40 (S409), whereupon this process ends (S410). When the two passwords agree (S407: “Yes”), a password agreement signal is transmitted from the MODEM 23 to the PC 40 (S411), and an indication, such as “Is History to be Erased?”, is displayed on the display 55 (S412). When the user manipulates the mouse 51 and clicks the button “YES” of buttons “YES” and “NO” displayed together with the indication, such as “Is History to be Erased?”, while watching the display 55 (S413: “Yes”), a history erasure signal is transmitted from the MODEM 57 of the PC 40 to the facsimile apparatus 1 (S414), and all the transmitted images stored in the transmitted-image saving RAM 24b are erased by the history erasure unit 30 within the facsimile apparatus 1 (S415). After the transmitted images have been erased, this process ends (S410). On the other hand, when the “NO” button is clicked by manipulating the mouse 51 (S413: “No”), this process is directly ended (S410). When it has been determined at the step S406 that the password is not stored in the printing-aspect saving RAM 24c of the facsimile apparatus 1 (S406: “No”), the routine shifts to the steps S412, et seq. Here, when the “YES” button displayed together with the indication, such as “Is History to be Erased?”, is clicked by manipulating the mouse 51 (S413: “Yes”), all the transmitted images stored in the transmitted-image saving RAM 24b are erased by the history erasure unit 30 (S415).

Due to such processing, when the administrator sets the password, he/she can be prevented from failing to check the transmitted image, for the reason that the data of the transmitted image are erased from the transmitted-image saving RAM 24b when any user other than the administrator has transmitted the image. Since the PC 40 is provided with the password input function 54, the administrator can input the password and erase the transmitted images without going to the place where the facsimile apparatus 1 is installed.

[Fourth Illustrative Aspect]

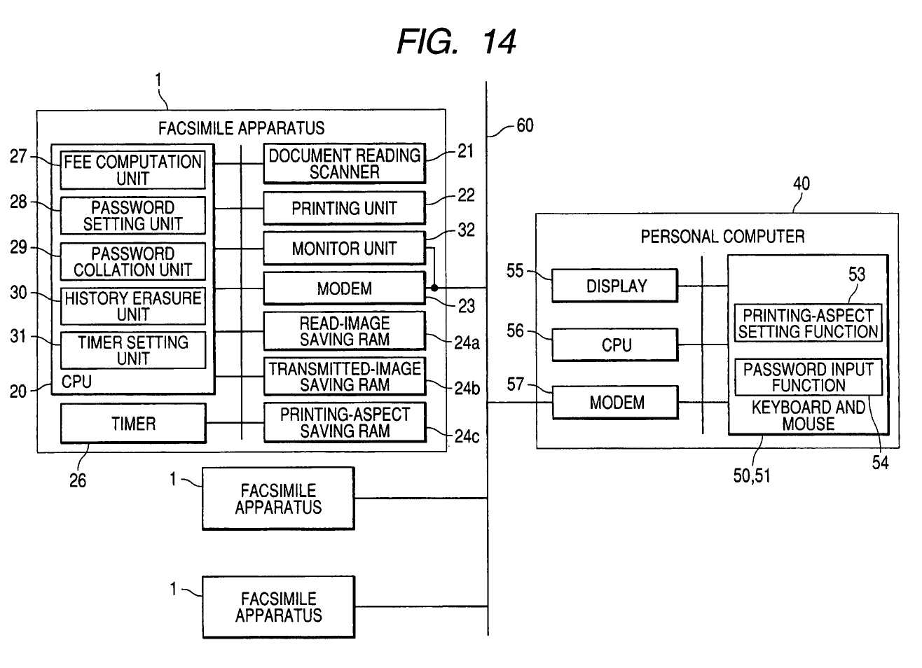

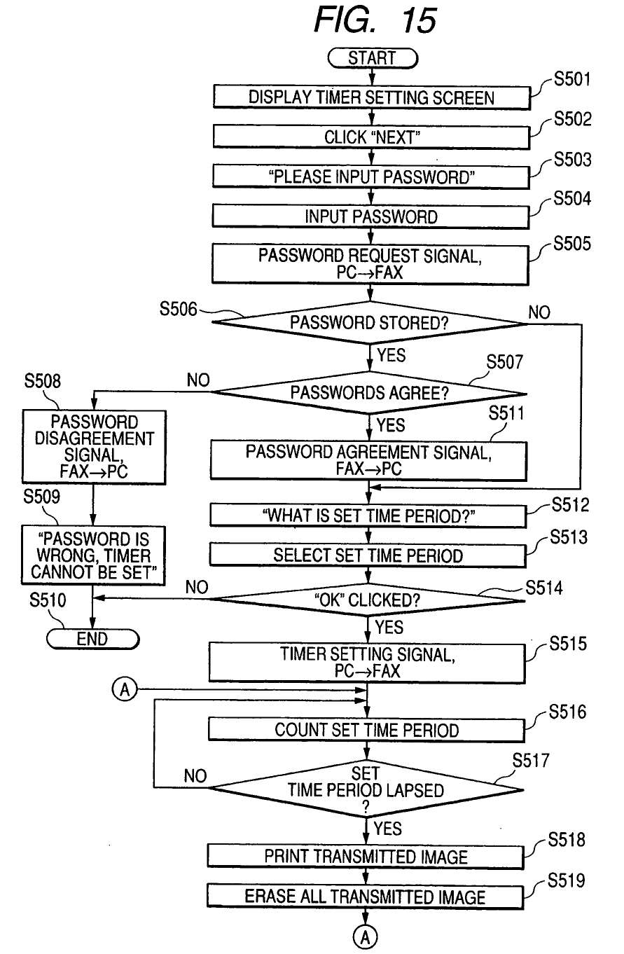

An image output system according to the fourth illustrative aspect of the present invention will be described with reference to the drawings. Incidentally, component parts corresponding to those of the first illustrative aspect, second illustrative aspect and third illustrative aspect will be assigned identical reference numerals and signs, and the repeated descriptions of the first illustrative aspect, second illustrative aspect and third illustrative aspect shall be omitted. FIG. 14 is a block diagram schematically representing the image output system of the fourth illustrative aspect. FIG. 15 is a flow chart showing the operation of a process for setting a time period by the timer setting unit 31, in the fourth illustrative aspect.

(Mutual Relations Among Various Constituents of Image Output System)

In this illustrative aspect as shown in FIG. 14, as the points of difference from the various constituents of the image output system in the third illustrative aspect as shown in FIG. 11, the history print function 52 as the history-printing instruction unit is not provided, and the CPU 20 as the control unit of the facsimile apparatus 1 is provided with the timer setting unit 31 to print transmitted images every predetermined time period.

The timer setting unit 31 is similar in function to the timer setting unit 31 in the second illustrative aspect, and in this illustrative aspect, a set time period is transmitted from the MODEM 57 to each facsimile apparatus 1 and stored in the printing-aspect saving RAM 24c in order that the transmitted images may be printed every set time period by the printing-aspect setting function 53 by manipulating the keyboard 50 and the mouse 51 on the display 55. After the transmitted images have been printed, the data of the printed transmitted images are erased from the transmitted-image saving RAM 24b by the history erasure unit 30.

(Operation of Process for Printing Transmitted Images on Basis of Timer Setting)

The printing process operation of the transmitted images as based on timer setting will be described with reference to the flow chart of FIG. 15.

As shown in FIG. 15, when the keyboard 50 or mouse 51 of the PC 40 is first manipulated by a user, a timer setting screen is displayed on the display 55 by the printing-aspect setting function 53 (S501). When the “Next” button or the like is clicked (S502), an indication, such as “Please Input Password”, is displayed on the display 55 by the password input function 54 (S503). When the user inputs a password by manipulating the keyboard 50 while watching the display 55 (S504), a password request signal is transmitted from the MODEM 57 of the PC 40 to the printing-aspect saving RAM 24c through the CPU 20 of the facsimile apparatus 1 (S505). Subject to the decision that a password is stored in the printing-aspect saving RAM 24c of the facsimile apparatus 1 (S506: “Yes”), whether or not the password inputted by the keyboard 50 and the password stored in the printing-aspect saving RAM 24c agree is collated by the password collation unit 29 (S507). When the two passwords do not agree (S507: “No”), a password disagreement signal is transmitted from the MODEM 23 of the facsimile apparatus 1 to the PC 40 (S508), and an indication, such as “Password is Wrong, and Timer Cannot be Set”, is displayed on the display 55 of the PC 40 (S509), then this process ends (S510). When the two passwords agree (S507: “Yes”), a password agreement signal is transmitted from the MODEM 23 of the facsimile apparatus 1 to the PC 40 (S511), and an indication, such as “What is Set Time Period?” is displayed on the display 55 (S512). The user selects a time period desired to be set, from among time periods displayed on the display 55 (here, “One Day”, “One Hour” and “One Week”), by manipulating the mouse 51 (S513). The user clicks a “YES” button displayed on the display 55 (S514: “Yes”). Then, a timer setting signal is transmitted from the PC 40 to the facsimile apparatus 1 (S515), and the timer setting unit 31 stores the set time period in the printing-aspect saving RAM 24c on the basis of the received timer setting signal and causes the timer 26 to count the set time period (S516). When the user clicks a “NO” button (“cancel” button) displayed on the display 55 (S514: “No”), this process ends (S510). When the set time period has not lapsed (S517: “No”), the counting by the timer 26 is continued. When the set time period has lapsed (S517: “Yes”), the transmitted images are printed on the basis of a printing aspect, which has been set by manipulating the keyboard 50 and mouse 51 that have the printing-aspect setting function 53 (S518). When the transmitted images have been printed, the data of the printed transmitted images are all erased from the transmitted-image saving RAM 24b (S519). The routine returns to the step S516, and the set time period starts counting by the timer 26 again. Meanwhile, when it has been determined at the step S506 that the password is not stored in the printing-aspect saving RAM 24c (S506: “No”), the routine shifts to the steps S512, et seq., and timer setting is performed. Before the operation of this process is performed from the step S501 again, the steps S516 to S519 are repeated. In a case where this process operation is performed from the step S201 again, it is performed with a new set time period, and the steps S516 to S519 are repeated with the new set time period before this process operation is subsequently performed from the step S501 again.

Due to such a process, the transmitted images subjected to the FAX transmissions can be printed. Therefore, even in a case where the read images are directly FAX-transmitted at the time, for example, when a large quantity of documents are to be FAX-transmitted quickly, whether the images are free from image quality defects and have been properly transmitted can be checked. The transmitted images can be automatically printed by the timer 26, so that when the timer 26 is set in conformity with, for example, the closing time of a shop, all data transmitted during one day can be efficiently checked at the business end of that day automatically every day. Even when a user who is unaccustomed to the manipulations of the facsimile apparatus 1 and the PC 40 does not perform the manipulations, the transmitted images can be automatically printed by the timer setting unit 31. When an administrator sets the password, any other user except the administrator can be prevented from freely setting the timer. In addition, even when the administrator does not input the password for every operation, the transmitted images can be erased. Still further, since the PC 40 is provided with the password input function 54, the administrator can input the password without going to the place where the facsimile apparatus 1 is installed, whereby he/she can perform the setting of printing the transmitted images every predetermined time period and erasing the transmitted images after the printing.

[Modified Illustrative Aspects]

Although the present invention has thus far been described in conjunction with the illustrative aspects, the invention is not restricted to the foregoing illustrative aspects at all, but it is capable of various improvements and modifications within a scope not departing from the technical idea thereof.

In the foregoing illustrative aspects, in the case where the transmitted images are erased from the transmitted-image saving RAM 24b by the history erasure unit 30, all the transmitted images stored in the transmitted-image saving RAM 24b are erased. However, the transmitted images to be erased may well be selected as explained below, in order that transmitted images desired to be still saved may be left behind.

<Selection of Transmitted Images to be Erased>

In a case where an administrator or the like has reinputted a set password and where the reinputted password has agreed with a stored password, or in a case where a password is not stored in the printing-aspect saving RAM 24c, the transmitted images to be erased by the history erasure unit 30 are permitted to be selected by manipulating the selection unit (corresponding to the printing-aspect setting key 11 in the first illustrative aspect, or corresponding to the keyboard 50 and mouse 51 in the third illustrative aspect).

<Operation of Process for Selecting Transmitted Images to be Erased>

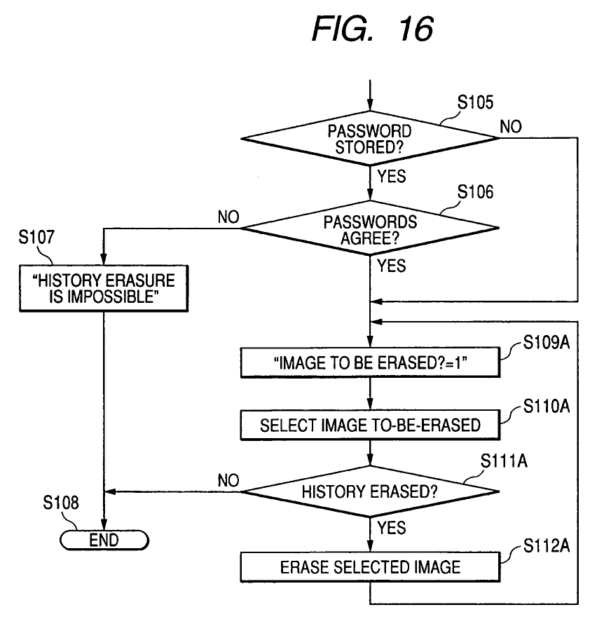

The operation of a process for selecting the transmitted images to-be-erased by the printing-aspect setting key 11 of the facsimile apparatus 1 furnished with the history print key 9 as in the first illustrative aspect will be described with reference to FIG. 16. FIG. 16 is a flow chart representing the operation of the process for selecting the transmitted images to be erased by the printing-aspect setting key 11. Since the processing of and before a step S108 is the same as the processing of the steps S101 to S108 shown in FIG. 8, it shall be omitted from description.

In the case where the password inputted by the dial keys 6 and the password stored in the printing-aspect saving RAM 24c have agreed (S106: “Yes”), or in the case where the password is not stored in the printing-aspect saving RAM 24c (S105: “No”), the setting of the images to-be-erased is performed. At this time, an indication, such as “Image to be Erased?=1” is displayed on the liquid crystal panel 10 (S109A). When the user selects the number of the transmitted images to-be-erased by depressing the keys of the right-and-left directions among the selection keys 11a while watching the liquid crystal panel 10 (S110A), he/she can alter a numeral (here, “1”) displayed on the liquid crystal panel 10. When the user alters the numeral displayed on the liquid crystal panel 10, to “3” and then depresses the determination button 11b (S111A: “Yes”), the data of the transmitted images transmitted by the third transmission job are erased from the transmitted-image saving RAM 24b by the history erasure unit 30 (S112A). Thereafter, the routine returns to the step S109A, and this process is repeated until the transmitted images to be erased become nonexistent. Numerals, which indicate the sequence of transmissions, may be printed as header information in printing the transmitted images. In a case where the determination button 11b has not been depressed in spite of the counting of a predetermined time period by the timer 26, it is judged that the setting of the transmitted images to be erased has been cancelled (S111A: “No”), and this process ends (S108).

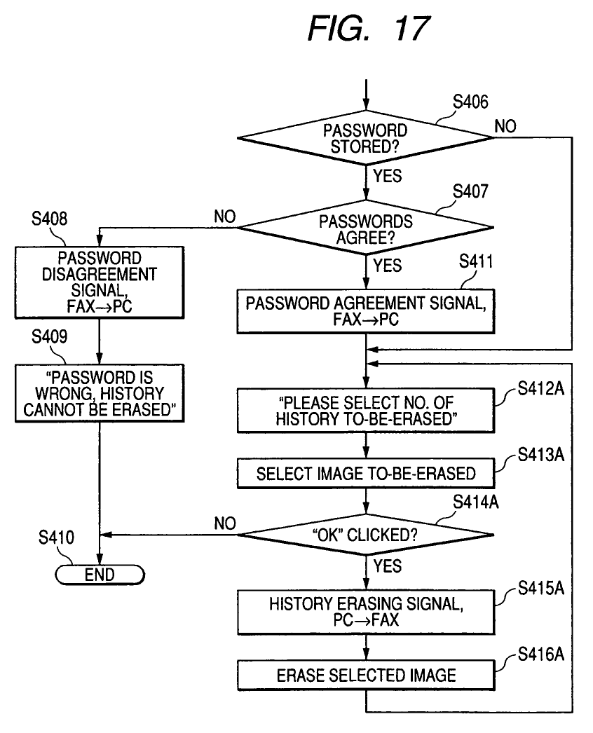

The operation of a process for selecting the transmitted images to-be-erased by the keyboard 50 and mouse 51 of the PC 40 furnished with the history print function 52 as in the third illustrative aspect will be described with reference to FIG. 17. FIG. 17 is a flow chart representing the operation of the process for selecting the transmitted images to-be-erased by the keyboard 50 and mouse 51. Since the processing of and before a step S411 is the same as the processing of the steps S401 to S411 shown in FIG. 13, it shall be omitted from description.

In the case where the password inputted by the keyboard 50 or mouse 51 having the password input function 54 and the password stored in the printing-aspect saving RAM 24c have agreed (S407: “Yes”) or where the password is not stored in the printing-aspect saving RAM 24c (S406: “No”), the setting of the images to-be-erased is performed. At this time, on the display 55 of the PC 40, an erasure-image setting screen is displayed, and an indication, such as “Please Select number of History to-be-Erased”, is displayed (S412A). When a user selects the number of the transmitted images to-be-erased by manipulating the keyboard 50 or mouse 51 while watching the display 55 (S413A) and selects, for example, “3” and then clicks an “OK” button on the display 55 (S414A: “Yes”), a history erasing signal for the transmitted images “3” is transmitted from the PC 40 to the facsimile apparatus 1 (S415A), and the data of the transmitted images transmitted by the third transmission job are erased from the transmitted-image saving RAM 24b by the history erasure unit 30 (S416A). Thereafter, the routine returns to the step S412A, and this process is repeated until the transmitted images to be erased become nonexistent. On the other hand, when a “Cancel” button on the display 55 is clicked (S414A: “No”) the display of the erasure-image setting screen is released, and this process ends (S410).

When the transmitted images to be erased are selected as stated above, the unnecessary transmitted images can be selectively erased, and the necessary transmitted images can remain.

The correct password must be inputted in order to set the timer 26, but in an environment where any user may set the timer 26, the timer 26 can be set without inputting any password.

The history print key 9 may well be disposed so as to be concave relative to the upper surface of the body case 2 of the facsimile apparatus 1. Thus, the history print key 9 can be prevented from being depressed by a part of the user's body due to the erroneous touch of the user with the facsimile apparatus 1.

It can be set whether only the head transmitted image of each transmission job or all the pages thereof is/are to be printed, but the history print function may well be set so as to be capable of re-designating a printing range in such a manner that the transmitted images of the first through fifth pages are to be printed. Thus, in a situation where it suffices to check whether only some of the FAX-transmitted documents were properly transmitted, at the time, for example, when new documents obtained by correcting the initial several pages of the documents FAX-transmitted last are to be retransmitted, the printing of the transmitted images of the pages, which need not be checked can be omitted, and hence, it is permitted to save the amount of sheets.

When any of the various printing aspects is to be set by the printing-aspect setting key 11 disposed in the facsimile apparatus 1, in a case where the printing aspect is to be cancelled midway of the setting operation, a cancellation button not shown may well be disposed in the manipulation portion 3 so as to return the display of the liquid crystal panel 10 into an initial state before the setting operation, by depressing the button.

Both the history print key 9 or history print function 52 and the timer setting unit 31 may well be disposed in the facsimile apparatus 1 or the PC 40 so as to be capable of selecting whether the transmitted images are to be printed using the history print key 9, or the transmitted images are to be printed every predetermined time period by the timer setting unit 31, by the printing-aspect setting key 11 or printing-aspect setting function 53. Thus, even when the environment of use of the facsimile apparatus 1 or the PC 40 has changed, the transmitted images can be printed by the appropriate printing method.

The start time of the time period as to which the transmission fees of the transmitted images are to be computed, or the start time of the time period as to which the transmitted images are to be printed, is set as “one day after” or “one week before”, but the start time may well be set by a date as “Aug. 15, 2005”.

The setting of the printing aspect, which is represented by a numeral, such as a time period or the number of pages, may well be performed using the dial keys 6. To set the numeral by using the dial keys 6 is easier and less laborious than to set the numeral by using the selection keys 11a.

What is claimed is:

1. A communication equipment comprising:
an image reading unit that reads an image on a sheet;
a read-image storage unit that stores the image read by the image reading unit;
a first transmission unit that transmits the image stored in the read-image storage unit to an external equipment according to a transmission job;
a monitor unit that determines whether or not the image is transmitted to the external equipment by the first transmission unit;
a history-image storage unit that stores a history image, which is determined to be transmitted to the external equipment by the monitor unit;
a history-printing instruction unit that gives an instruction to print a plurality of pages of the history image, stored in the history-image storage unit, on every one sheet according to a manipulation; and
a printing unit that prints the plurality of pages of the history image on every one sheet on a basis of the instruction from the history-printing instruction unit.

2. The communication equipment as defined in claim 1, wherein
in response to depressing the history-printing instruction unit once, the printing unit prints the plurality of pages of the history image on every one sheet.

3. The communication equipment as defined in claim 1, further comprising:
a printing-aspect setting unit that sets a printing aspect of the history image to be printed on a sheet by the printing unit;
a display unit that displays the printing aspect;
a printing-aspect storage unit that stores the printing aspect displayed on the display unit; and
a control unit that controls the history image to be printed on the sheet on a basis of the printing aspect stored in the printing-aspect storage unit.

4. The communication equipment as defined in claim 3, wherein
the display unit displays a first setting screen through which a number of pages of the history image to be printed on one sheet is inputted,
the printing-aspect setting unit sets the number of pages of the history image to be printed on one sheet inputted through the first setting screen displayed by the display unit,
the printing-aspect storage unit stores the number of pages of the history image to be printed on one sheet set by the printing-aspect setting unit, and
the control unit controls the history image of the number of pages stored in the printing-aspect storage unit to be printed on every one sheet.

5. The communication equipment as defined in claim 3, wherein
the display unit displays a first selection screen through which a first setting to print only the history image of a head page of each transmission job or to print the history image of all pages of each transmission job is selected,
the printing-aspect setting unit sets the first setting selected through the first selection screen displayed by the display unit,
the printing-aspect storage unit stores the first setting set by the printing-aspect setting unit, and
the control unit controls the printing unit to print only the history image of the head page of each transmission job or the history image of all the pages of each transmission job on a basis of the first setting stored in the printing-aspect storage unit.

6. The communication equipment as defined in claim 5, wherein
in response to setting the first setting to print the history image of the head page and an other page of each transmission job by the printing-aspect setting unit, the display unit displays a second selection screen through which second setting to print the history image of the other page of each transmission job with a size equal to a size of the history image of the head page of each transmission job or to print with a size smaller than the size of the history image of the head page of each transmission job is selected,
the printing-aspect setting unit sets the second setting selected through the second selection screen displayed by the display unit,
the printing-aspect storage unit stores the second setting set by the printing-aspect setting unit, and
the control unit controls the printing unit to print the history image of the other page of each transmission job with the size equal to the size of the history image of the head page of each transmission job or with the size smaller than the size of the history image of the head page of each transmission job on a basis of the second setting stored in the printing-aspect storage unit.

7. The communication equipment as defined in claim 3, further comprising a timekeeping unit, wherein
the display unit displays a second setting screen through which a time period is inputted,
the printing-aspect setting unit sets the first time period inputted through the second setting screen displayed by the display unit,
the printing-aspect storage unit stores the first time period set by the printing-aspect setting unit, and
in response to counting an elapse of the first time period since the printing-aspect storage unit stores the first time period, the control unit controls the printing unit to print the history image transmitted after the first time period.

8. The communication equipment as defined in claim 3, further comprising a fee computation unit that computes a transmission fee of the history image within a predetermined term, wherein
the display unit displays a third setting screen through which a second time period is inputted,
the printing-aspect setting unit sets the second time period inputted through the third setting screen displayed by the display unit,
the printing-aspect storage unit stores the second time period set by the printing-aspect setting unit,
in response to counting an elapse of the second time period since the printing-aspect storage unit stores the second time period, the fee computation unit computes the transmission fee of the history image transmitted after the second time period, and
the control unit controls the printing unit to print the transmission fee of the history image computed by the fee computation unit together with the history image.

9. The communication equipment as defined claim 1, wherein
the printing unit prints header information at an upper end part or a lower end part of the sheet on which the image read by the image reading unit is formed, and transmission information of the image transmitted by the first transmission unit together with the history image.

10. The communication equipment as defined in claim 3, further comprising:
a password input unit that inputs a first password and a second password;
a password setting unit that stores the first password inputted by the password input unit in the printing-aspect storage unit;
a password collation unit that determines whether or not the first password set by the password setting unit and the second password inputted by the password input unit agree; and
a history erasure unit that erases the history image from the history-image storage unit in response to determining that the first password and the second password agree.

11. The communication equipment as defined in claim 10, further comprising a selection unit that selects the history image to be erased by the history erasure unit.

12. A communication equipment comprising:
an image reading unit that reads an image on a sheet;
a read-image storage unit that stores the image read by the image reading unit;
a first transmission unit that transmits the image stored in the read-image storage unit to an external equipment according to a transmission job;
a monitor unit that determines whether or not the image is transmitted to the external equipment by the first transmission unit;
a history-image storage unit that stores a history image, which is determined to be transmitted to the external equipment by the monitor unit;
a printing unit that prints the history image stored in the history-image storage unit;
a timer setting unit that sets a time period so that the printing unit prints the history image every time period;
a timekeeping unit that counts the time period set by the timer setting unit; and
a control unit that controls a plurality of pages of the history image to be printed on every one sheet and every time period counted by the timekeeping unit.

13. The communication equipment as defined in claim 12, further comprising:
a password input unit that inputs a first password and a second password;
a printing-aspect storage unit that stores the first password inputted by the password input unit;
a password setting unit that stores the first password inputted by the password input unit in the printing-aspect storage unit; and
a password collation unit that determines whether or not the second password inputted by the password input unit and the first password stored in the printing-aspect storage unit agree, wherein
in response to determining that the first password and the second password agree, the timer setting unit is capable of setting the time period, thereby printing the history image every time period.

14. The communication equipment as defined in claim 12, further comprising a history erasure unit that erases the history image, which is printed by the printing unit.

15. The communication equipment as defined in claim 14, further comprising a selection unit that selects the history image to be erased by the history erasure unit.

16. An image output system characterized by comprising:
a communication equipment; and
an information terminal device, wherein
the communication equipment comprises:
an image reading unit that reads an image on a sheet;
a read-image storage unit that stores the image read by the image reading unit;
a first transmission unit that transmits the image stored in the read-image storage unit to an external equipment according to a transmission job;
a monitor unit that determines whether or not the image is transmitted to the external equipment by the first transmission unit; and
a history-image storage unit that stores a history image, which is determined to be transmitted to the external equipment by the monitor unit,
the information terminal device comprises a history-printing instruction unit that gives an instruction to print a plurality of pages of the history image, stored in the history-image storage unit, on every one sheet, according to a manipulated, and
the communication equipment further comprises a printing unit that prints the plurality of pages of the history image on every one sheet on a basis of the instruction from the history-printing instruction unit.

17. The image output system as defined in claim 16, wherein
the information terminal device further comprises:
a printing-aspect setting unit that sets a printing aspect of the history image to be printed on a sheet by the printing unit;
a display unit that displays the printing aspect set by the printing-aspect setting unit; and
a second transmission unit that transmits the printing aspect set by the printing-aspect setting unit to the communication equipment, and
the communication equipment further comprises:
a printing-aspect storage unit that stores the printing aspect transmitted from the information terminal device by the second transmission unit; and
a control unit that controls the plurality of pages of the history image to be printed on every one sheet on a basis of the printing aspect stored in the printing-aspect storage unit.

18. The image output system as defined in claim 17, wherein
the display unit displays a first setting screen through which a number of pages of the history image to be printed on one sheet is inputted,
the printing-aspect setting unit sets the number of pages of the history image to be printed on one sheet inputted through the first setting screen displayed by the display unit,
the printing-aspect storage unit stores the number of pages of the history image to be printed on one sheet set by the printing-aspect setting unit, and
the control unit controls the history image of the number of pages stored in the printing-aspect storage unit to be printed on every one sheet.

19. The image output system as defined in claim 17, wherein
the display unit displays a first selection screen through which a first setting to print only the history image of a head page of each transmission job or to print the history image of the head page and an other page of each transmission job is selected,
the printing-aspect setting unit sets the first setting selected through the first selection screen displayed by the display unit,
the printing-aspect storage unit stores the first setting set by the printing-aspect setting unit, and
the control unit controls the printing unit to print only the history image of the head page of each transmission job or the history image of the head page and the other page of each transmission job on a basis of the first setting stored in the printing-aspect storage unit,

20. The image output system as defined in claim 19, wherein
in response to setting the first setting to print the history image of the head page and the other page of each transmission job by the printing-aspect setting unit, the display unit displays a second selection screen through which second setting to print the history image of the other page of each transmission job with a size equal to a size of the history image of the head page of each transmission job or to print with a size smaller than the size of the history image of the head page of each transmission job is selected,
the printing-aspect setting unit sets the second setting selected through the second selection screen displayed by the display unit,
the printing-aspect storage unit stores the second setting set by the printing-aspect setting unit, and
the control unit controls the printing unit to print the history image of the other page of each transmission job with the size equal to the size of the history image of the head page of each transmission job or with the size smaller than the size of the history image of the head page of each transmission job on a basis of the second setting stored in the printing-aspect storage unit.

21. The image output system as defined in claim 17, wherein
the communication equipment further comprises a timekeeping unit,
the display unit displays a second setting screen through which a time period is inputted,
the printing-aspect setting unit sets the first time period inputted through the second setting screen displayed by the display unit,
the printing-aspect storage unit stores the first time period set by the printing-aspect setting unit, and
in response to counting an elapse of the first time period since the printing-aspect storage unit stores the first time period, the control unit controls the printing unit to print the history image transmitted after the first time period.

22. The image output system as defined in claim 17, wherein
the communication equipment further comprises a fee computation unit that computes a transmission fee of the history image within a predetermined term,
the display unit displays a third setting screen through which a second time period is inputted,
the printing-aspect setting unit sets the second time period inputted through the third setting screen displayed by the display unit,
the printing-aspect storage unit stores the second time period set by the printing-aspect setting unit,
in response to counting an elapse of the second time period since the printing-aspect storage unit stores the second time period, the fee computation unit computes the transmission fee of the history image transmitted after the second time period, and
the control unit control the printing unit to print the transmission fee of the history image computed by the fee computation unit together with the history image.

23. The image output system as defined in claim 16, wherein
the printing unit prints header information at an upper end part or a lower end part of the sheet on which the image read by the image reading unit is formed, and transmission information of the image transmitted by the first transmission unit together with the history image.

24. The image output system as defined in claim 16, wherein
the information terminal device further comprises a password input unit that inputs a first password and a second password, and
the communication equipment further comprises:
a password setting unit that stores the first password inputted by the password input unit in the printing-aspect storage unit;
a password collation unit that determines whether or not the first password set by the password setting unit and the second password inputted by the password input unit agree; and
a history erasure unit that erases the history image from the history-image storage unit in response to determining that the first password and the second password agree.

25. The image output system as defined in claim 24, wherein
the information terminal device further comprises a selection unit that selects the history image to be erased by the history erasure unit.

26. An image output system comprising:
a communication equipment; and
an information terminal device, wherein
the communication equipment comprises:
an image reading unit that reads an image on a sheet;
a read-image storage unit that stores the image read by the image reading unit;
a first transmission unit that transmits the image stored in the read-image storage unit to an external equipment according to a transmission job;
a monitor unit that determines whether or not the image is transmitted to the external equipment by the first transmission unit;
a history-image storage unit that stores a history image, which is determined to be transmitted to the external equipment by the monitor unit; and
a printing unit that prints the history image stored in the history-image storage unit, and
the information terminal device comprises:
a timer setting unit that sets a time period so that the printing unit prints the history image every time period;
a timekeeping unit that counts the time period set by the timer setting unit; and
a control unit that controls a plurality of pages of the history image to be printed on every one sheet and every time period counted by the timekeeping unit.

27. The image output system as defined in claim 26, wherein
the information terminal device further comprises:
a password input unit that inputs a first password and a second password; and
a second transmission unit that transmits the first password inputted by the password input unit to the communication equipment,
the communication equipment further comprises:
a printing-aspect storage unit that stores the first password transmitted by the second transmission unit;
a password setting unit that stores the first password transmitted by the second transmission unit in the printing-aspect storage unit; and
a password collation unit that determines whether or not the second password inputted by the password input unit and the first password stored in the printing-aspect storage unit agree, and
in response to determining that the password set by the password collation unit and the stored password agree, the timer setting unit is capable of setting the time period, thereby printing the history image every time period.

28. The image output system as defined in claim 26, wherein
the communication equipment further comprises a history erasure unit that erases the history image, which is printed by the printing unit.

29. The image output system as defined in claim 28, wherein
the information terminal device further comprises a selection unit that selects the history image to be erased by the history erasure unit.
